(19) United States
(12) Patent Application Publication
(10) Pub. No.: US 2014/0141161 A1
(43) Pub. Date: May 22, 2014

(54) SPRAYABLE FLAME RESISTANT POLYURETHANE COATING COMPOSITION

(71) Applicant: Christian Bruchertseifer, Tecklenburg (DE)

(72) Inventor: Christian Bruchertseifer, Tecklenburg (DE)

(73) Assignee: Dow Global Technologies LLC, Midland, MI (US)

(21) Appl. No.: 14/125,346

(22) PCT Filed: Jun. 25, 2012
(86) PCT No.: PCT/US2012/043955

§ 371 Date: Dec. 11, 2013

Related U.S. Application Data
(60) Provisional application No. 61/501,936, filed on Jun. 28, 2011.

(51) Int. Cl. C09D 5/18; B05D 1/02

(52) U.S. Cl. CPC C09D 5/18; B05D 1/02
USPC 427/209; 524/706; 524/712

(57) ABSTRACT

The present invention relates to a flexible polyurethane coating composition for application, preferably by spraying, to a substrate to protect and or improve the properties of the substrate. Specifically, the coating composition is a reactive polyurethane formulation which forms an elastomeric polyurethane coating with improved flammability properties. The reactive formulation comprises an A side comprising an isocyanate prepolymer with optional flame retardant compounds and a B side comprising a dispersion of red phosphorous, with optional additional flame retardant compounds, in an aromatic polyester polyol.

### FIELD OF THE INVENTION

The present invention relates to a coating composition for application to a substrate to protect and or improve the properties of the substrate. Specifically, the coating composition is a reactive polyurethane formulation which forms an elastomeric polyurethane coating with improved flammability properties. Preferably the substrate is a foamed polymer.

### BACKGROUND OF THE INVENTION

Coating compositions are used in a wide variety of industries for a wide variety of applications. Such industries may include but are not limited to landcraft such as cars, trucks, sport utility vehicles, motorcycles; watercraft such as boats, ships and submarines; aircraft such as airplanes and helicopters, industrial such as commercial equipment and structures including walls and roofs; construction such as construction vehicles and structures including walls and roofs; and the like. In these industries, considerable efforts have been expended to develop coating compositions with improved properties. Coatings are used to protect various applications against damage due to corrosion, abrasion, impact, chemicals, ultraviolet light, other environmental exposure, and especially heat and flame.

Many different types of said applications comprise a foamed substrate. Polyurethane foams, for example, have many useful advantages such as good cushioning properties, acoustical and thermal insulation, ease of processing, low cost, and light weight. Elastomeric polyurethane foams are widely used in cushioning materials while semi-rigid and/or rigid polyurethane foams are used as insulation materials and impact absorbing materials. However, conventional polyurethane foams often present serious fire hazards. Attempts have been made to produce flame-retardant polyurethane foams by the use of flame-retarding raw materials or by after-treatment of the foam products. Although some of these materials can pass a cigarette burn test which has a mild ignition source, it is difficult to add a large amount of fire-retardant materials in the foam, and thus many of these foams are not effective under more severe ignition sources or burning conditions. Large amounts of fire-retardant additives often have deleterious effects on other properties (i.e., physical, thermal, and the like) of the foam making them unsuitable for their intended application. In addition, many of the fire-retardant chemicals required in these foams are expensive in nature, which in turn contributes to the high cost of the foam article.

It is an object of this invention to provide a protective layer on a substrate, especially a foamed substrate so as to reduce the flammability characteristics of the resulting product.

### SUMMARY OF THE INVENTION

The present invention is such a reactive formulation composition and method for making a sprayable elastomeric polyurethane coating having improved flame retardant properties comprising: (A) an A side comprising an isocyanate prepolymer component comprising: (i) an isocyanate prepolymer, preferably having a NCO level of from 10 to 20 weight percent based on the weight of the isocyanate prepolymer, and (ii) optionally a flame retardant additive, preferably trichloro propylphosphate and (B) a B side comprising an aromatic polyester polyol component comprising: (iii) an aromatic polyester polyol, preferably having a viscosity at 25° C. measured according to ASTM D455 of from 500 cP to 2,000 cP, (iv) red phosphorous, preferably microencapsulated red phosphorous, and (v) one or more additional component selected from a catalyst; a chain extender; an additional flame retardant, preferably selected from expandable graphite, aluminum trihydrate, magnesium hydroxide, trichloro propylphosphate, 3,4,5,6-tetrabromo-1,2-benzene-dicarboxylic acid, or zinc borate; a cross linker; pigments; a dispersant; an antisettling agent; a defoamer; or a reactive diluent.

Another embodiment of the present invention is a process for coating a surface of a substrate to form an elastomeric polyurethane coating on the substrate surface comprising: (1) providing a substrate with a surface; (2) spraying the surface of the substrate with the reactive formulation disclosed herein above; and (3) subjecting the resulting layer of reactive formulation to conditions sufficient to cure the reactive formulation to form an elastomeric polyurethane coating on the substrate surface.

Preferably, in the process disclosed herein above the substrate comprises wood, glass, metal, concrete, a roofing material, a polymeric material, or a combinations thereof, preferably the substrate comprises a foamed polymeric material, preferably the foamed polymeric material is polyethylene, polystyrene, or polyurethane.

### DETAILED DESCRIPTION OF THE INVENTION

The present invention is a reactive formulation for making a sprayable elastomeric polyurethane coating having improved flame retardant properties. Preferably, said reactive formulation is sprayed on one or more surface of a substrate forming an article with an elastomeric polyurethane coating having improved flammability performance. The substrate to be coated may comprise any suitable material such as wood, glass, metal, concrete, roofing material such as bituminous sheet, plastic, preferably the substrate is plastic, i.e., a polymeric material, or combinations thereof. Further, when the substrate is a polymeric material is may be solid (i.e., non-foam) or foam. If it is a foam, it may be an elastomeric foam, a rigid foam, or a semi-rigid foam depending on the desired use of the coated article. Suitable polymeric materials maybe made thermoplastic or thermoset. In the case of foamed plastics, preferable polymeric materials are polyolefins (PO) such as polyethylene (PE) and polypropylene (PP); copolymer of polyethylene and polypropylene; polystyrene (PS), high impact polystyrene (HIPS) or expanded polystyrene (EPS), or extruded polystyrene foam (XPS); styrene and acrylonitrile copolymer (SAN); acrylonitrile, butadiene, and styrene terpolymer (ABS); polycarbonate (PC); vinyls such as polyvinyl chloride (PVC); polyphenylene oxide and polystyrene blend (PPO or PPE); polyurea; silicones; epoxy (EP); and polyurethane (PU). A most preferable foam substrate is a rigid polyurethane foam or a flexible polyurethane foam. When a polymeric foam is used as the substrate, and especially when a polyurethane foam is used, there will be good adhesion between the sprayable polyurethane coating of the present invention and the foam substrate.

The sprayable reactive formulation of the present invention contains one or more fire retardant additive which provides improved flammability performance for the resulting coated substrate. The reactive formulation of the present invention comprises an A side comprising an isocyanate prepolymer component and a B side comprising an aromatic polyester polyol component comprising red phosphorous dispersed in an aromatic polyester polyol. Once the reactive formulation of the present invention is mixed and sprayed, it reacts, cures, and forms an elastomeric polyurethane coating.

The A side comprises an isocyanate prepolymer component comprises an isocyanate prepolymer. Suitable organic isocyanates for use in the composition and process of the present invention include any of those known in the art for the preparation of polyurethane coatings, like aliphatic, cycloaliphatic, araliphatic and, preferably, aromatic isocyanates, such as toluene diisocyanate in the form of its 2,4 and 2,6-isomers and mixtures thereof and diphenylmethane diisocyanate in the form of its 2,4′-, 2,2′- and 4,4′-isomers and mixtures thereof, the mixtures of diphenylmethane diisocyanates (MDI) and oligomers thereof having an isocyanate functionality greater than 2 known in the art as “crude” or polymeric MDI (polymethylene polyphenylene polyisocyanates), the known variants of MDI comprising urethane, allophanate, urea, biuret, carbodiimide, uretonimine and/or isocyanurate groups.

Preferably monomeric MDI, crude MDI, polymeric MDI, combinations thereof, and/or liquid variants thereof are obtained by introducing uretonimine and/or carbodiimide groups into said polyisocyanates, such a carbodiimide and/or uretonimine modified polyisocyanate having an NCO value of from 29 to 33 percent and includes 1 to 45 percent by weight of 2,4′-diphenylmethane diisocyanate in the form of a monomer and/or a carbodiimidization product thereof. For a good description of such carbodiimide and/or uretonimine modified polyisocyanates see U.S. Pat. No. 6,765,034, which is incorporated by reference herein in its entirety.

In the present invention, the organic isocyanate component may include one or more organic polyisocyanate, in addition to and/or in place of monomeric MDI as needed, provided other polyisocyanate compounds do not have adverse influences on the performance on the desired sound deadening, vibration management, and flame resistance properties of the elastomeric polyurethane coating. To polyisocyanate compounds may also be selected from among organic isocyanates such as tolylene diisocyanate (TDI), isopholone diisocyanate (IPDI) and xylene diisocyanates (XDI), and modifications thereof. These isocyanates may be used in combinations of two or more types.

The reactive formulation which produces the elastomeric polyurethane coating layer of the present invention comprises one or more isocyanate prepolymer. Preferably, the isocyanate prepolymer is one or more isocyanate-terminal prepolymer which is formed by a reaction between at least one of the compounds of the above-indicated mono or polymeric isocyanate and suitable active hydrogen compounds, preferably a polyamine or a polyol. Suitable polyamines may be numerous and selected from a wide variety known in the art. Non-limiting examples of suitable polyamines may include but are not limited to primary, secondary and tertiary amines, and mixtures thereof. Suitable polyols may be numerous and selected from a wide variety known in the art. Non-limiting examples of suitable polyols may include but are not limited to polyether polyols, polyester polyols, polycaprolactone polyols, polycarbonate polyols, polyurethane polyols, poly vinyl alcohols, polymers containing hydroxy functional acrylates, polymers containing hydroxy functional methacrylates, polymers containing allyl alcohols and mixtures thereof.

Suitable amines for use in the present invention can be selected from a wide variety of known amines such as primary and secondary amines, and mixtures thereof. In alternate embodiments, the amine may include monoamines, or polyamines having at least two functional groups such as di-, tri-, or higher functional amines; and mixtures thereof. In further embodiments, the amine may be aromatic or aliphatic such as cycloaliphatic, or mixtures thereof. Non-limiting examples of suitable amines may include aliphatic polyamines such as but not limited to ethylamine, isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexa-hydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

Non-limiting examples of secondary amines can include mono- and poly-acrylate and methacrylate modified amines; polyaspartic esters which can include derivatives of compounds such as maleic acid, fumaric acid esters, aliphatic polyamines and the like; and mixtures thereof. In an embodiment of the present invention, the secondary amine includes an aliphatic amine, such as a cycloaliphatic diamine. Such amines are available commercially from Huntsman Corporation (Houston, Tex.) under the designation of JEFFLINK such as JEFFLINK 754.

Suitable polyols for the preparation of the isocyanate-terminal prepolymer are reaction products of alkylene oxides, for example ethylene oxide and/or propylene oxide, with initiators containing from 2 to 8 active hydrogen atoms per molecule. Suitable initiators include: polyols, for example ethylene glycol, diethylene glycol, propylene glycol, dipropylene glycol, butane diol, glycerol, trimethylolpropane, triethanolamine, pentaerythritol and sorbitol; polyamines, for example ethylene diamine, tolylene diamine, diaminodiphenylmethane and polymethylene polyphenylene polyamines; and aminoalcohols, for example ethanolamine and diethanolamine; and mixtures of such initiators. Other suitable polyols include polyesters obtained by the condensation of appropriate proportions of glycols and higher functionality polyols with polycarboxylic acids. Still further suitable polyols include hydroxyl terminated polythioethers, polyamides, polyesteramides, polycarbonates, polyacetals, polyolefins and polysiloxanes. Preferred polyols are the polyether polyols comprising ethylene oxide and/or propylene oxide units and most preferably polyoxyethylene polyoxypropylene polyols having an oxyethylene content of at least 10 percent and preferably 10 to 85 percent by weight.

Preferably, the polyisocyanate prepolymer used to make elastomeric polyurethane coating of the present invention have an NCO level of from 10 to 20 weight percent, more preferably 11.5 to 17 weight percent based on the weight of the isocyanate prepolymer.

The reactive formulation which produces the elastomeric polyurethane coating layer of the present invention comprises a B side which comprises an aromatic polyester polyol component. The aromatic polyester polyol component which can be used in the present invention comprises an aromatic polyester polyol which may be an aromatic polyester polyol or a combination of aromatic polyester polyol and a polyether polyol.

The elastomeric polyurethane coating layer can be prepared by reacting an aromatic polyester polyol comprising at least one acid component (e.g., sodium 5-sulfoisophthalate, isophthalic acid, terephthalic acid, etc.) and at least one alcohol component (e.g., butanediol, neopentyl glycol, 1,6-hexanediol, 2-butene-1,4-diol, 3-chloro-1,2-propanediol, cyclohexanediol, 3-cyclohexene-1,1-dimethanol, decalindiol, etc.) with a diisocyanate prepolymer such as an aromatic diisocyanate prepolymer (e.g., tolylenediisocyanate capped prepolymer, diphenylmethanediisocyanate capped prepolymer, xylylenediisocyanate capped prepolymer, etc.) and/or an aliphatic diisocyanate prepolymer (e.g., hexamethylene-diisocyanate capped prepolymer, isophoronediisocyanate capped prepolymer, methylenebis(4-cyclohexylisocyanate) capped prepolymer, etc.).

Preferably, the aromatic polyester polyol used in the present invention has a number average molecular weight of from 400 to 5,000, more preferably of from 400 to 3,500 and more preferably of form 400 to 1,000. Preferably, the aromatic polyester polyol used in the present invention has a glass-transition temperature equal to or less than 40° C., more preferably equal to or less than 20° C.

To adjust the glass transition temperature, the aromatic polyester polyol component, it may comprise one or more of a (long-chain)aliphatic polyester polyol (e.g., polybutylene adipate, polyhexamethylene adipate, polyethylene adipate, etc.), a polycaprolactone, an aliphatic polyetherpolyol, an aromatic polyol, or a polyetherpolyol (e.g., polytetramethylene glycol, polyethylene glycol, polypropylene glycol, etc.).

Suitable aromatic polyester polyols are derived from phthalic acid, isophthalic acid, terephthalic acid, hexahydro isophthalic acid, phthalic anhydride, scrap of polyethylene terephthalate, dimethyl terephthalate process residue, and the like. These acids and/or anhydrides may be used singly or in combination of two or more. Preferred aromatic polyester polyols include aromatic polyester polyols obtained by a reaction between an aromatic polycarboxylic acid and/or anhydride with a polyol having a low molecular weight and a side chain(s) or the like, such as diethylene glycol, triethylene glycol, dipropylene glycol, tripropylene glycol, neopentyl glycol, hydroxy pivalic acid-2,2-dimethyl-3-hydroxy propyl, ethylene glycol, 1,2-propylene glycol, 1,3-propylene glycol, 1,3-butylene glycol, 1,4-butylene glycol, 2,2-dimethyl-1,3-propane diol, 1,6-hexane diol, 3-methyl-1,5-pentane diol, 1,8-octane diol, and the like. Preferred polyester polyol component comprise isophthalic acid, terephthalic acid, and neopentyl glycol or caprolactone, isophthalic acid, and neopentyl glycol, and the like.

The aromatic polyester polyol component used in the present invention preferably contains 60 to 100 parts by weight of an aromatic polyester polyol. When the content of the aromatic polyester polyol is less than 60 parts by weight, the elastomeric polyurethane coating layer derived therefrom may not provide adequate flame retardant performance.

The aromatic polyester polyol component for use in the preparation of the elastomeric polyurethane coatings of the present invention have a hydroxyl number of equal to or greater than 50, preferably equal to or greater than 80, more preferably equal to or greater than 100, more preferably equal to or greater than 150. Hydroxyl number indicates the number of reactive hydroxyl groups available for reaction. It is expressed as a number of milligrams of potassium hydroxide equivalent to the hydroxyl content of one gram of polyol. The aromatic polyester polyol component for use in the preparation of the elastomeric polyurethane coatings of the present invention have a hydroxyl number of equal to or less than 400, preferably equal to or less than 350, more preferably equal to or less than 300, more preferably equal to or less than 250.

The aromatic polyester polyol component preferably have a functionality of from 2 to 8, preferably 2 to 6, preferably 2 and an average hydroxyl number preferably from about 100 to 850, more preferably from about 150 to 750, and more preferably 200 to 650. The aromatic polyester polyol component may have a viscosity at 25° C. of 500 cP or greater, as measured according to ASTM D455. In some embodiments the aromatic polyester polyol may have a higher viscosity, of 2,000 cP or less. Preferably, the polyol or polyols have an average molecular weight of from 100 to 10,000, more preferably of from 200 to 5,000.

The B side comprising an aromatic polyester polyol component further comprises inorganic red phosphorus. The inorganic red phosphorus may be untreated or may have been surface treated by an inorganic substance and/or organic substance (sometimes referred as coated or microencapsulated red phosphorus), and the like. It is especially preferable to use coated red phosphorus in terms of the stability and ease of handling. Examples of commercial red phosphorus products include NOVA RED™ and NOVA EXCEL™ available from Rin Kagaku Kogyo Co., HISHIGUARD™ available from Nippon Chemical Industries Co., and EXOLIT™ RP607 available from Clariant.

The red phosphorous may be added to the aromatic polyester polyol neat, as a concentrate, or used as a mixture, solution, or a thixotropic dispersion in a carrier medium such as castor oil, diphenyloctylphosphate, tris(chloropropyl)phosphate (TCPP), etc., for example EXOLIT RP 6590 (TP) and EXOLIT RP 6580 available from Clariant. Preferably, the red phosphorous is a dispersion in the aromatic polyester polyol.

The red phosphorus is present in an amount of equal to or greater than 1 part based on the total weight of the B side, preferably equal to or greater than 2 parts, preferably equal to or greater than 3 parts, preferably equal to or greater than 4 parts, and more preferably equal to or greater than 5 parts based on the total weight of the B side. The red phosphorus is present in an amount of equal to or less than 30 parts based on the total weight of the B side, preferably equal to or less than 20 parts, preferably equal to or less than 15 parts, preferably equal to or less than 12.5 parts, and more preferably equal to or less than 10 parts based on the total weight of the B side.

One or more additional flame retardant additive may be present in the reactive formulation of the present invention, see U.S. Pat. Nos. 4,254,177 and 6,274,639, both of which are incorporated herein by reference in their entirety. For example, the additional flame retardant additive may comprise a halogen containing compound such as 3,4,5,6-tetra-bromo 1,2-benzenedicarboxylic acid (PHT-4-Diol) or trichlorpropylphosphate (TCPP); a phosphorus containing compound such as phosphate, e.g., ammonium polyphosphate or a phosphonate; an inorganic filler such as alumina trihydrate (ATH) especially fine grained ATH or magnesium hydroxide; an expandable graphite; a silicate such as sodium silicate or alumosilicate; melamine; zinc borate; antimony (III) oxide; zinc stannate; or combinations thereof. Said additional flame retardant additive(s) may be comprised (1) exclusively in the A side, (2) exclusively in the B side, or (3) partially in the A side and partially in the B side. Preferably the additional flame retardant additive(s) are suspended, dispersed, and/or dissolved in the A side, B side, or both sides prior to mixing and reacting the A side with the B side.

If present, each additional flame retardant may independently used in an amount equal to or greater than 1 parts based on the total weight of the A side or B side which it is located in, preferably equal to or greater than 5 part, preferably equal to or greater than 7 part, and more preferably equal to or greater than 10 parts based on the total weight of the A side or B side which it is located in. If present, each additional flame retardant may independently used in an amount of equal to or less than 30 parts based on the total weight of the A side or B side which it is located in, preferably equal to or less than 20 parts, and more preferably equal to or less than 15 parts based on the total weight of the A side or B side which it is located in.

Suitable expandable graphite for use in the present invention include crystalline compounds that maintain the laminar structure of the carbon that has grown a graphite interlayer compound by treating natural flaky graphite, pyrolytic graphite, Kish graphite, or another such powder by concentrated sulfuric acid, nitric acid, or another such inorganic acid and concentrated nitric acid, perchloric acid, permanganic acid, bichromate, or another such strong oxidizing agent. Expandable graphite that has been neutralized by ammonia, an aliphatic lower amine, alkali metal compound, alkaline earth metal compound, or the like is preferably used. Examples of aliphatic lower amines include monomethyl amine, dimethyl amine, trimethyl amine, ethyl amine, and the like. Examples of alkali metal compounds and alkaline earth metal compounds include hydroxides, oxides, carbonates, sulfates, organic acid salts, and the like of potassium, sodium, calcium, barium, magnesium, and the like. Preferably expandable graphite flakes have a size of from 0.3 to 1.0 mm.

In one embodiment, the expandable graphite being used is formed of graphite, with H₂SO₄ or SO₄, for example, having two free negative valences, which attach to two free positive valences of a hydrocarbon ring, incorporated between the planes of the graphite mesh. When an elastomeric polyurethane coating comprising this graphite is burned, the graphite expands to from 100 to 200 times its volume, giving off SO₃ and/or SO₂ and water. A loose, expanded mass that acts in an insulating manner thus forms. Examples of commercial expandable graphite products include NYAGRAPH™ available from Naycol Nano Technologies, Inc., CA-60S™ available from Nippon Kasei Chemical Co., and CALLOTEK™ available from Graphitwerk Kropfmuehlm AG.

If used, the expandable graphite is present in an amount of equal to or greater than 1 parts based on the total weight of the A side or B side which it is located in, preferably equal to or greater than 5 parts, preferably equal to or greater than 10 part, and more preferably equal to or greater than 15 parts based on the total weight of the A side or B side which it is located in. The expandable graphite is present in an amount of equal to or less than 30 parts based on the total weight of the A side or B side which it is located in, preferably equal to or less than 25 parts, and more preferably equal to or less than 20 parts based on the total weight of the A side or B side which it is located in.

The reactive formulation which produces the elastomeric polyurethane coating layer of the present invention may further comprise one or more additional component, for example one or more catalyst may be present in the B side of the reactive formulation. One preferred type of catalyst is a tertiary amine catalyst. The tertiary amine catalyst may be any compound possessing catalytic activity for the reaction between a polyol and an organic polyisocyanate and at least one tertiary amine group. Representative tertiary amine catalysts include trimethylamine, triethylamine, dimethylethanolamine, N-methyl-morpholine, N-ethyl-morpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl) ether, morpholine, 4,4′-(oxydi-2,1-ethanediyl)bis, triethylenediamine, pentamethyl diethylene triamine, dimethyl cyclohexyl amine, N-acetyl N,N-dimethyl amine, N-coco-morpholine, N,N-dimethyl aminomethyl N-methyl ethanol amine, N,N,N′-trimethyl-N′-hydroxyethyl bis(aminoethyl) ether, N,N-bis(3-dimethylaminopropyl)N-isopropanolamine, (N,N-dimethyl) amino-ethoxy ethanol, N,N,N′,N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis (propylamine), (dimethyl(aminoethoxyethyl))((dimethyl amine)ethyl)ether, tris(dimethyl-amino propyl) amine, dicyclohexyl methyl amine, bis(N,N-dimethyl-3-aminopropyl) amine, 1,2-ethylene piperidine and methyl-hydroxyethyl piperazine

The B side of the reactive formulation may contain one or more other catalysts, in addition to or instead of the tertiary amine catalyst mentioned above. Of particular interest among these are organotin catalysts such as tin carboxylates and tetravalent tin compounds. Examples of these include stannous octoate, dibutyl tin diacetate, dibutyl tin dilaurate, dibutyl tin dimercaptide, dialkyl tin dialkylmercapto acids, dibutyl tin oxide, dimethyl tin dimercaptide, dimethyl tin diisooctylmercaptoacetate, and the like.

Catalysts are typically used in small amounts. For example, the total amount of catalyst used may be 0.0015 to 5 weight percent, preferably from 0.01 to 1 weight percent based on the total weight of the isocyanate prepolymer component. Organometallic catalysts are typically used in amounts towards the low end of these ranges.

The B side may further comprise as one of the additional components a cross linker, which preferably is used, if at all, in small amounts, to 2 weight percent, up to 0.75 weight percent, or up to 0.5 weight percent based on the total weight of the isocyanate prepolymer component. The cross linker contains at least three isocyanate-reactive groups per molecule and has an equivalent weight, per isocyanate-reactive group, of from 30 to about 125 and preferably from 30 to 75. Aminoalcohols such as monoethanolamine, diethanolamine and triethanolamine are preferred types, although compounds such as glycerine, trimethylolpropane and pentaerythritol also can be used.

A chain extender may be employed as an additional component in the B side of the reactive formulation of the present invention. A chain extender is a compound having exactly two isocyanate-reactive groups and an equivalent weight per isocyanate-reactive group of up to 499, preferably up to 250, also may be present. Chain extenders, if present at all, are usually used in small amounts, such as up to 10, preferably up to 5 and more preferably up to 2 weight percent based on the total weight of the isocyanate prepolymer component. Examples of suitable chain extenders include ethylene glycol, diethylene glycol, triethylene glycol, propylene glycol, dipropylene glycol, tripropylene glycol, 1,4-dimethylolcyclohexane, 1,4-butane diol, 1,6-hexane diol, 1,3-propane diol, diethyltoluene diamine, amine-terminated polyethers such as JEFFAMINE™ D-400 from Huntsman Chemical Company, amino ethyl piperazine, 2-methyl piperazine, 1,5-diamino-3-methyl-pentane, isophorone diamine, ethylene diamine, hexane diamine, hydrazine, piperazine, mixtures thereof and the like.

The B side may also comprise as an additional component a filler. The filler may constitute up to about 25 percent, of the total weight of the polyurethane reactive formulation (i.e., the combined weight of the isocyanate prepolymer component and the polyester polyol component). Suitable fillers include molecular sieves, such as zeolith powder, talc, mica, wollastonite, montmorillonite, marble, barium sulfate (barytes), milled glass granite, milled glass, calcium carbonate, aluminum trihydrate, carbon, aramid, silica, silica-alumina, zirconia, talc, bentonite, antimony trioxide, kaolin, coal based fly ash and boron nitride.

Other additives typically used in reactive formulations to make elastomeric polyurethane coatings may be used, for example pigments such as titanium dioxide (TiO₂), process chemicals such as dispersants, antisettling agents, defoamers, reactive diluents, and the like.

By proper use of the type and concentration of catalyst system and other additives, the cure rate and density of the elastomeric polyurethane coating can be tailored depending on the particular characteristics desired. The present invention is advantageous in that a durable, low density polyurethane coating can be made which is also a high build coating. Depending on the application, coating thicknesses may range from 0.01 mm to 10 mm. Typically, thicknesses between 0.5 mm to 10 mm are achieved. The polyurethane coating of the invention will generally have a tack-free cure time in less than an hour.

The elastomeric polyurethane coatings according to the invention also have good durability. Durability is reflected by properties such as Shore A hardness, tensile strength and % elongation at failure. Polyurethane coatings according to the invention generally have a Shore A hardness ranging from about 50 to 100, preferably 70 to 90, tensile strength (stress at maximum load) ranging from about 50 to about 1000 psi, and a percent elongation at failure ranging from about 50 to about 400 percent.

Conventional spray systems can be used to apply the elastomeric polyurethane coating of the invention. For example, a standard polyester “gel coat” type spray system may be used that has a main positive displacement fluid pump that can siphon feed the uniform polyisocyanate/polyol mixture from an open bucket reservoir, or can be pressure fed from a pressure pot. Coupled to the displacement pump is a catalyst slave pump that dispenses the catalyst into the coating stream via an external spray nozzle. Numerous types of spray guns are adaptable to this equipment including conventional air spray, airless, air assisted airless, and HVLP spray guns. In general, the elastomeric polyurethane coating of the invention can be sprayed through any conventional spray gun that can be modified to accept an external catalyst mix to the spray fan, including automatic versions of the spray gun for integration into robotic spraying applications. The polyisocyanate prepolymer/polyester polyol reactive formulation mixture may be heated prior to spraying, however in some embodiments because of the low viscosity of the polyisocyanate prepolymer/polyester polyol reactive formulation mixture, heating said mixture prior to spraying in not required.

In one embodiment, the present invention is a process for coating a surface of a substrate to form an elastomeric polyurethane coating on the substrate surface comprising: (1) providing a substrate with a surface; (2) spraying the surface of the substrate with a reactive formulation comprising: (A) an A side comprising an isocyanate prepolymer component comprising: (i) an isocyanate prepolymer, and (ii) optionally a flame retardant additive, and (B) a B side comprising an aromatic polyester polyol component comprising: (iii) an aromatic polyester polyol, (iv) red phosphorous, and (v) one or more additional component selected from a catalyst, a chain extender, an additional flame retardant, a cross linker, pigments, a dispersant, an antisettling agent, a defoamer, or a reactive diluent, wherein forming a layer of reactive formulation on the surface of the substrate; and (3) subjecting the resulting layer of reactive formulation to conditions sufficient to cure the reactive formulation to form an elastomeric polyurethane coating on the substrate surface.

The elastomeric polyurethane coating of the present invention may be employed in applications by contacting it with a surface of a substrate, such as that found in or on a storage container, shipping container, rail car, waste container, pallet, or the like. It may also be suitably employed for hard surfaces such as panels, doors, flooring, pavement or the like. The elastomeric polyurethane coating of the present invention is especially well suited as a sprayable coating on a foam substrate, preferably polyurethane foams, preferably in insulation type applications.

The elastomeric polyurethane coating of the present invention has demonstrated usefulness in the shipbuilding, civil engineering, mining, land craft, water craft, aircraft, and construction industries. An example in the shipping industry is coating foam that is used as cryogenic tank and pipe insulation for the use of handling liquid propylene or natural gas (LPG and LNG). Coating such foam with the elastomeric polyurethane coating of the present invention protects it against humidity and mechanical impact during assembly of the gas tanks and transportation. Further, it improves the flame resistant properties of the foam.

Moreover, the elastomeric polyurethane coating of the present invention can be used in, or as, lacquers and paints.

The foregoing may be better understood by the following Examples, which are presented for purposes of illustration and are not intended to limit the scope of this invention.

### EXAMPLES

Examples 2 to 4 are respectively 30, 40, and 50 weight percent dispersions of red phosphorous in an aromatic polyester polyol (Example 1). Their compositions and properties are described in Table 1.

TABLE 1

| Example | 1 | 2 | 3 | 4 |
|---|---|---|---|---|
| IP 9001 Polyester Polyol, wt. % | 100 | 70 | 60 | 50 |
| Red Phosphorous, wt. % | | 30 | 40 | 50 |
| Hydroxyl number, mg KOH/g, | 210 | 145 | 123 | 103 |
| ASTM D 4274 | | | | |
| Viscosity @ 23° C., mPas, ASTM | 500 | 5850 | 9750 | 17900 |
| D 445 | | | | |
| Density 20° C., g/ml, ISO 2811 | 1.0 | 1.37 | 1.40 | 1.50 |

IP 9001 Polyester Polyol is an aromatic polyester having MW of 2,000 diluted with diethylene glycol available from The Dow Chemical Co.
Red Phosphorous is a microencapsulated red phosphorous dispersed in IP 9001 Polyester Polyol

Example 5 is a B side aromatic polyester polyol component of the present invention and its composition is listed in Table 2.

Example 6 is an A side polyisocyanate prepolymer component of the present invention and its composition is listed in Table 3.

Example 7 is a sprayable rigid polyurethane foam system VORACOR™ CY 3076/CY 3120 coated with an elastic polyurethane coating of the present invention having a thickness of about 3 mm made from mixing and spraying the reactive formulation formed by combining the A side of Example 6 and the B side of Example 5. Flammability performance and physical properties for Example 7 are listed in Table 4.

TABLE 2

| Example 5 | Parts | Wt. % |
|---|---|---|
| Composition | | |
| Example 2 | 15 | 14.3 |
| IP 9001 Polyester Polyol | 17.4 | 16.6 |
| PHT-4-Diol | 10 | 9.5 |
| 1,4-Butanediol | 10.2 | 9.7 |
| MARTINAL ™ OL 104 LEO | 12 | 11.4 |
| MAGNIFIN ™ H 10 A | 12 | 11.4 |
| ES 100 C 10 | 13 | 12.3 |
| BYK ™ W 995 | 0.5 | 0.5 |
| ANTITERRA ™ 203 | 0.2 | 0.2 |
| DABCO ™ 33-S catalyst | 1.3 | 1.2 |
| ISOPUR ™ SU-0435/9121 | 5 | 4.8 |
| FOMREZ ™ UL 38 | 0.1 | 0.1 |
| BYK 066 | 0.8 | 0.8 |
| TIONA ™ RCL 552 | 5 | 4.8 |
| Zeolith powder | 2.5 | 2.4 |

1,4 Butane diol is a cross linker available from BASF
PHT-4 Diol is 3,4,5,6-tetrabromo-1,2-benzenedicarboxylic acid, mixed esters with diethylene glycol and propylene glycol available from Air Products
MARTINA1 OL 104 LEO is a fine grained alumina trihydrate available from Albemarle
MAGNIFIN H 10 A is magnesium hydroxide avaialble from Albemarle
Zeolith powder is a molecular sieve available from Grace Corporation
BYK W 995 is a dispersive and antisettling agent available from Byk
BYK 066 is a defoamer available from Byk/Altana
ANTITERRA 203 is an antisettling agent available from Byk
DABCO 33-S is a tertiary amine catalyst available from Air Products
FOMREZ UL 38 is an organotin catalyst available from Momentive
ES 100 C 10 is an expandable graphite (maximum 100 microns) available from Graphit Kropfmühl
TIONA RCL 552 (TiO2) is titanium dioxide available from Huntsman
ISOPUR SU 4235/9121 is a black paste from iSL Chemie

TABLE 3

| Example 6 | |
|---|---|
| Composition | Wt. % |
| Benzoyl Chloride | 0.006 |
| ISONATE ™ M 125 MDI | 3.168 |
| VORANOL ™ 1010 L Polyol | 5.67 |
| ISONATE OP 30 Pure MDI | 12.528 |
| TCPP | 15 |
| ISONATE ™ M 143 Modified MDI | 15.942 |
| VORANOL 2000L Polyol | 22.686 |
| VORANATE ™ M 229 Polymeric MDI | 25 |

ISONATE OP 30 is methylene diphenylenediisocyanate available from The Dow Chemical Co.
ISONATE M 125 is methylene diphenylenediisocyanate available from The Dow Chemical Co.
ISONATE M 143 is a modified methylene diphenylenediisocyanate available from The Dow Chemical Co.
VORANATE M 229 is polymeric methylene diphenylenediisocyanate available from The Dow Chemical Co.
VORANOL 2000 L is a polyether diol with a 2,000 MW available from The Dow Chemical Co.
VORANOL 1010 L is a polyether diol with a 1,000 MW available from The Dow Chemical Co.
TCPP is trichlorpropylphosphate available from ICL

Mixing ratio of the A side:B side is 1:1 by weight; however 1:1 by volume is also within the scope of the present invention. The components are processed via low pressure (2 bars) spray equipment, using a static-dynamic mixing tube, the components are feed at about 20 to 25 grams per second (g/s), with a polyol temperature of 60° C., and an isocyanate prepolymer temperature of 30° C. The surface appearance or spray pattern, is determined visually, if it is smooth and glossy it is rated good, if it is wavy and/or very irregular (coarse) it is rated poor.

The test sample is a block of rigid polyurethane foam with the dimensions 50 cm by 50 cm by 10 cm which is coated on one side with an elastomeric polyurethane coating of the present invention. The sample is placed in a cylindrical tube measuring 140 cm by 75 cm which can be made from ductile cast iron or steel (V2A). The tube has an opening for a chimney measuring 90 cm by 22 cm on top to allow observation of smoke emission and whether the smoke is black smoke. The flame source is a welding torch with excess of oxygen in the acetylene/oxygen mix (temperature equal to or greater than 1,400° C.) which is placed through a rectangular opening in the cylindrical tube (measuring 40 cm by 15 cm) and the torch is held perpendicular to the surface of the coated sample for 90 seconds in the tube. The distance of the opening to the sample is about 25 cm. The tip of flame touches the surface of the coating.

Test Criteria: Whether the flame penetrates the coating or the coating maintains its integrity is observed. Once the torch is removed, if the coating ignites, is it self-extinguishing? If there is black smoke, how long to evolution (evolution for less than 40 seconds is acceptable). A material passes the test if all three requirements are matched or exceeded, e.g., the coating maintains its integrity, it is self extinguishing, and it takes less than 40 seconds for the evolution of black smoke to stop.

The following performance parameters are observed and the time in seconds (s) to occurrence is noted: smoke evolution, black smoke evolution, and extinguishing time. Also, whether or not char was developed and if it was the size of the charred area are noted and measured in centimeters (cm) and whether the rigid foam adjacent to the coating collapsed, or cratered, is observed. The integrity of the coating at the point of, and after, flame application is observed, the level of char shield is determined subjectively and rated as soft, moderate, tough, or extremely tough.

TABLE 4

| Example 7 | |
|---|---|
| Composition | |
| Example 2, parts | 100 |
| Example 5, parts | 100 |
| Performance | |
| Surface spray pattern | Good |
| Fire Test Parameters | |
| Smoke evolution, seconds | 80 |
| Black smoke development, seconds | None |
| Extinguishing time, seconds | 15 |
| Char | Yes |
| Charred area diameter, cm | 18 |
| Formation of crater | None |
| Char shield | Moderate |
| Physical Properties | |
| Shore A/D | 58D |
| Tensile strength, N/mm², DIN 53504 | 14.4 |
| Tear strength, N/mm, DIN 53515 | 64 |
| Elongation @ break, %, DIN 53504 | 40 |

1. A reactive formulation for making a sprayable elastomeric polyurethane coating having improved flame retardant properties comprising:
(A) an A side comprising an isocyanate prepolymer component comprising:
(i) an isocyanate prepolymer,
and
(ii) optionally a flame retardant additive
and
(B) a B side comprising an aromatic polyester polyol component comprising:
(iii) an aromatic polyester polyol,
(iv) red phosphorous,
and
(v) one or more additional component selected from a catalyst, a chain extender, an additional flame retardant, a cross linker, pigments, a dispersant, an antisettling agent, a defoamer, or a reactive diluent.

2. The reactive formulation of claim 1 wherein the red phosphorous is microencapsulated.

3. The reactive formulation of claim 1 wherein the A side further comprises trichloro propylphosphate as the additional flame retardant additive and the B side comprises one or more additional flame retardant additive selected from expandable graphite, aluminum trihydrate, magnesium hydroxide, trichloro propylphosphate, 3,4,5,6-tetrabromo-1,2-benzenedicarboxylic acid, or zinc borate.

4. The reactive formulation of claim 1 wherein the polyisocyanate prepolymer has an NCO level of from 10 to 20 weight percent based on the weight of the isocyanate prepolymer.

5. The reactive formulation of claim 1 wherein the aromatic polyester polyol has a viscosity at 25° C. measured according to ASTM D455 of from 500 cP to 2,000 cP.

6. A process for coating a surface of a substrate to form an elastomeric polyurethane coating on the substrate surface comprising:
(1) providing a substrate with a surface;
(2) spraying the surface of the substrate with a reactive formulation comprising:
(A) an A side comprising an isocyanate prepolymer component comprising:
(i) an isocyanate prepolymer,
and
(ii) optionally a flame retardant additive
and
(B) a B side comprising an aromatic polyester polyol component comprising:
(iii) an aromatic polyester polyol,
(iv) red phosphorous,
and
(v) one or more additional component selected from a catalyst, a chain extender, an additional flame retardant, a cross linker, pigments, a dispersant, an antisettling agent, a defoamer, or a reactive diluent,
wherein forming a layer of reactive formulation on the surface of the substrate;
and
(3) subjecting the resulting layer of reactive formulation to conditions sufficient to cure the reactive formulation to form an elastomeric polyurethane coating on the substrate surface.

7. The process of claim 6 wherein the substrate comprises wood, glass, metal, concrete, a roofing material, a polymeric material, or a combinations thereof.

8. The process of claim 6 wherein the substrate comprises a foamed polymeric material.

9. The process of claim 8 wherein the substrate comprises polyethylene, polystyrene, or polyurethane.
